(19) United States
(12) Patent Application Publication
(10) Pub. No.: US 2023/0315271 A1
(43) Pub. Date: Oct. 5, 2023

(54) COLLABORATIVE WHITEBOARD FOR MEETINGS

(71) Applicants: SONY GROUP CORPORATION, Tokyo (JP); SONY INTERACTIVE ENTERTAINMENT LLC, San Mateo, CA (US)

(72) Inventors: JAMES R. MILNE, RAMONA, CA (US); CHARLES MCCOY, SAN DIEGO, CA (US); TRUE XIONG, SAN DIEGO, CA (US)

(21) Appl. No.: 17/698,465

(22) Filed: Mar. 18, 2022

(51) Int. Cl. G06F 3/0482; G06F 3/0354; G06F 3/14; G06F 3/04883; G06F 3/04847

(52) U.S. Cl. CPC G06F 3/1454; G06F 3/03545; G06F 3/0482; G06F 3/04847; G06F 3/04883; G06F 3/04845; G06F 2203/04803

(57) ABSTRACT

An electronic device and method for collaboration among whiteboard user interfaces (Uls) for meetings is provided. The electronic device controls a display device coupled to the electronic device, to display a first whiteboard UI which is electronically linked with one or more second whiteboard Uls of participant devices for a duration of a meeting session. The electronic device receives inputs corresponding to strokes of a digital pen device on a whiteboard UI of the one or more second whiteboard Uls and prepares content based on the inputs and one or more content filters. Thereafter, the electronic device controls the first whiteboard UI to render the prepared content.

### CROSS-REFERENCE TO RELATED APPLICATIONS/INCORPORATION BY REFERENCE

None.

### FIELD

Various embodiments of the disclosure relate to Internet technology and communication. More specifically, various embodiments of the disclosure relate to an electronic device and a method for collaboration among whiteboard user interfaces (Uls) for meetings.

### BACKGROUND

Advancements in information and communication technology have led to development of various meeting services and related applications that enable two or more devices to join and exchange information in a meeting session. Typically, a meeting client includes a whiteboard interface to facilitate participant(s) of the meeting session to provide handwritten inputs. For example, in a sales meeting, a participant may provide inputs in the form of hand drawn graphs or figures to illustrate sales of a product via a whiteboard interface displayed in a meeting client UI. Other participants who may want to contribute may have to wait for the participant to stop whiteboard sharing to start sharing their inputs via their whiteboard interface. In some instances, this may affect the length of the session and may lead to a weaker collaboration among the participants of the meeting session.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for collaboration among whiteboard user interfaces (UIs) for meetings, is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram that illustrates an exemplary network environment for collaboration among whiteboard user interfaces (Uls) for meetings, in accordance with an embodiment of the disclosure.

FIG. 2 is a block diagram that illustrates an exemplary electronic device for facilitation of collaboration among whiteboard Uls for meetings, in accordance with an embodiment of the disclosure.

FIG. 3 is a diagram that illustrates an exemplary scenario for authentication of a participant of a virtual meeting session, to use a digital pen device with a whiteboard UI, in accordance with an embodiment of the disclosure.

FIG. 4 is a diagram that illustrates an exemplary scenario for authentication of participants of a meeting session to use a digital pen device, in accordance with an embodiment of the disclosure.

FIG. 5 is a diagram that illustrates an exemplary scenario for preparation of content based on one or more content filters and inputs received through a digital pen device, in accordance with an embodiment of the disclosure.

FIG. 6 is a diagram that illustrates an exemplary scenario for preparation of content based on one or more content filters and inputs received through one or more digital pen devices, in accordance with an embodiment of the disclosure.

FIG. 7A is a diagram that illustrates an exemplary scenario for display of one or more whiteboard UIs as tiles on a window UI, in accordance with an embodiment of the disclosure.

FIG. 7B is a diagram that illustrates an exemplary scenario for display of prepared content on one or more whiteboard Uls inside a window UI, in accordance with an embodiment of the disclosure.

FIG. 8 is a diagram that illustrates an exemplary network environment for transmission of inputs to participant devices via a meeting server, in accordance with an embodiment of the disclosure.

FIG. 9 is a diagram that illustrates an exemplary scenario for rendering of within separate areas of a whiteboard UI, in accordance with an embodiment of the disclosure.

FIG. 10 is a flowchart that illustrates exemplary operations for collaboration among whiteboard Uls for meetings, in accordance with an embodiment of the disclosure.

### DETAILED DESCRIPTION

The following described implementations may be found in the disclosed electronic device and method for rendering a collaborative whiteboard user interface (UIs) for meetings. Exemplary aspects of the disclosure provide an electronic device (for example, a mobile phone, a desktop, a laptop, a personal computer, and the like). For a meeting session with participant devices, the electronic device may control a display device (for example, a television, a smart-glass device, a see-through display, a projection-based display, and the like) coupled to the electronic device, to display a first whiteboard UI. The first whiteboard UI may be electronically linked with one or more second whiteboard Uls of participant devices for a duration of a meeting session. At any time-instant, the electronic device may receive inputs which correspond to strokes of a digital pen device on a whiteboard UI of the one or more second whiteboard UIs. The electronic device may prepare content based on the inputs and one or more content filters. Thereafter, the electronic device may control the first whiteboard UI to render the prepared content.

Conventionally, a meeting client includes a whiteboard interface to facilitate participant(s) of the meeting session to provide handwritten inputs. Other participants who may want to contribute have to wait for the participant to stop whiteboard sharing to start sharing their inputs via their whiteboard interface. In some instances, this may affect the length of the session and may lead to a weaker collaboration among the participants of the meeting session. Also, conventional meeting clients (and respective whiteboard interfaces) do not efficiently address issues related to confidentiality and privacy (e.g., role-based or location-specific access) of content shared between participants of a meeting session. For example, all participants typically see the same content on UI of the meeting client and any participant can share the content via the whiteboard interface. In many meetings, there are some participants who are from the same organization and some participants (e.g., contractors, vendors, or client) join from outside of the organization. However, all the participants can view all the content shared in the meeting. Also, it can be difficult for the host of the meeting to verify the identity of all such participants, especially if there are many participants from same or different organizations/institutions.

In order to improve collaboration among the participants of the meeting session, the disclosed electronic device may render a whiteboard UI that may be linked or connected to whiteboard UIs of other electronic devices associated the meeting session. The whiteboard UI may render content based on inputs from all the whiteboard UIs. For example, a participant A may provide inputs to explain sales data for a product and a participant B may simultaneously provide inputs to explain marketing insights for the product. Both participants A and B may provide respective inputs through strokes on respective whiteboard UIs. The strokes may be rendered (in an order) on each whiteboard UI so that it appears that all participants are providing inputs on a common whiteboard UI. Any user or participant (upon authentication) can join in and share inputs on the interface.

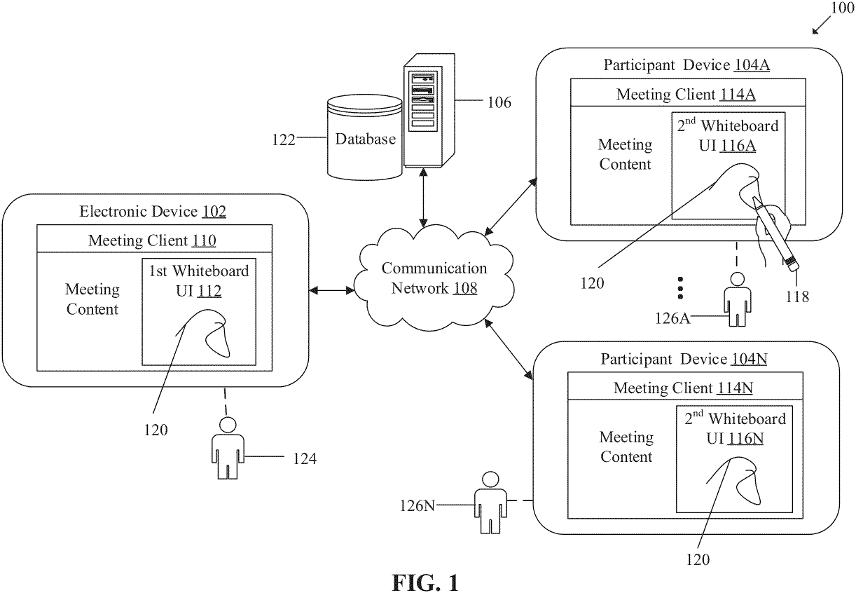

FIG. 1 is a diagram that illustrates an exemplary network environment for collaboration among whiteboard user interfaces (UIs) for meetings, in accordance with an embodiment of the disclosure, in accordance with an embodiment of the disclosure. With reference to FIG. 1, there is shown a network environment 100. The network environment 100 includes an electronic device 102, one or more participant devices 104A...104N, and a meeting server 106. The electronic device 102 may communicate with devices such as the one or more participant devices 104A...104N, or the meeting server 106, through one or more networks (such as a communication network 108).

The electronic device 102 may include a meeting client 110 that may allow the electronic device 102 to join or host a meeting session with the one or more participant devices 104A...104N. The meeting client 110 may allow the electronic device 102 to share meeting content and display a first whiteboard UI 112 on the meeting client 110. In accordance with an embodiment, the meeting client 110 may control multiple whiteboard Uls. A whiteboard UI may control multiple displays to show the whiteboard content.

Like the electronic device 102, the one or more participant devices 104A...104N may include one or more meeting clients 114A...114N, which may allow the one or more participant devices 104A...104N to join or host the meeting session. The one or more meeting clients 114A...114N may further allow the one or more participant devices 104A...104N to share meeting content and display one or more second whiteboard Uls 116A...116N. The first whiteboard UI 112 and the one or more second whiteboard Uls 116A...116N may receive inputs corresponding to strokes (such as the input 120 received by the second whiteboard UI 116A). The inputs may be received via digital pen devices (such as a first digital pen device 118) on a whiteboard UI (such as the second whiteboard UI 116A) in a participant device (such as the participant device 104A). In some embodiments, the meeting client 110 may control the first whiteboard UI 112 and the one or more second whiteboard Uls 116A...116N to render content prepared based on the received inputs and content filters. The meeting server 106 may include a database 122. There is further shown a participant 124 (e.g., a host or a participant of the meeting) who may be associated with the electronic device 102. There is further shown one or more participants 126A...126N associated with the one or more participant devices 104A...104N.

The electronic device 102 may include suitable logic, circuitry, interfaces, and/or code that may be configured to render content on the first whiteboard UI 112 based on inputs received from one or more second whiteboard Uls 116A...116N in a duration of a meeting session. The electronic device 102 may schedule, join, or initiate the meeting session by use of the meeting client 110. The meeting client 110 may enable display of the first whiteboard UI 112 and meeting content shared in the duration of the meeting session. Examples of the electronic device 102 may include, but are not limited to, a computing device, a desktop, a personal computer, a laptop, a computer workstation, a display monitor or a computer monitor, a tablet, a smartphone, a cellular phone, a mobile phone, a consumer electronic (CE) device having a display, a television (TV), a wearable display, a head mounted display, a digital signage, a digital mirror (or a smart mirror), a video wall (which consists of two or more displays tiled together contiguously or overlapped in order to form one large screen), or an edge device connected to a user’s home network or an organization’s network.

Each of the one or more participant devices 104A...104N may include suitable logic, circuitry, and interfaces that may be configured to render content on a whiteboard UI of the one or more second whiteboard UIs 116A...116N, based on inputs received from the first whiteboard UI 112 or other second whiteboard Uls of the one or more second whiteboard UIs 116A...116N in a duration of the meeting session. The one or more participant devices 104A...104N may schedule, join, or initiate the meeting session by use of the one or more meeting clients 114A...114N. Similar to the electronic device 102, examples of a participant device of the one or more participant devices 104A...104N may include, but are not limited to, a computing device, a desktop, a personal computer, a laptop, a computer workstation, a display monitor or a computer monitor, a tablet, a smartphone, a cellular phone, a mobile phone, a CE device having a display, a TV, a video projector, a touch screen, a wearable display, a head mounted display, a digital signage, a digital mirror (or a smart mirror), a video wall (which consists of two or more displays tiled together contiguously or overlapped in order to form one large screen), or an edge device connected to a user’s home network or an organization’s network.

The meeting server 106 may include suitable logic, circuitry, interfaces, and/or code that may be configured to render various services related to meeting session(s). For example, such services may include a server-enabled communication between meeting clients across devices, a server-enabled communication between whiteboards across devices, a feature that allows the meeting server 106 to support meeting sessions at the same time, a feature that allows the meeting server 106 to support receiving inputs provided on whiteboard Uls (as strokes using digital pen devices) during the meeting session, an option to generate an event stream that includes a sequence of strokes on the whiteboard Uls, an option to receive inputs that correspond to strokes of one or more digital pen devices on the whiteboard UIs, an option to transmit the inputs to the electronic device 102 and each of the one or more participant devices 104A...104N, and the like. The meeting server 106 may execute operations through web applications, cloud applications, HTTP requests, repository operations, file transfer, and the like. Examples of implementations of the meeting server 106 may include, but are not limited to, a database server, a file server, a web server, an application server, a mainframe server, a cloud computing server, or a combination thereof.

In at least one embodiment, the meeting server 106 may be implemented as a plurality of distributed cloud-based resources by use of several technologies that are well known to those ordinarily skilled in the art. A person of ordinary skill in the art will understand that the scope of the disclosure is not limited to the implementation of the meeting server 106 and the electronic device 102 (or each of the one or more participant devices 104A...104N) as two separate entities. In certain embodiments, the functionalities of the meeting server 106 can be incorporated in its entirety or at least partially in the electronic device 102 (or the one or more participant devices 104A...104N), without a departure from the scope of the disclosure.

The communication network 108 may include a communication medium through which the electronic device 102, the one or more participant devices 104A...104N, and the meeting server 106, may communicate with each other. The communication network 108 may be a wired or wireless communication network. Examples of the communication network 108 may include, but are not limited to, Internet, a Wireless Fidelity (Wi-Fi) network, a Personal Area Network (PAN), a Local Area Network (LAN), or a Metropolitan Area Network (MAN).

Various devices in the network environment 100 may be configured to connect to the communication network 108, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity(Li-Fi), 802.16, IEEE 802.11s, IEEE 802.11g, multi-hop communication, wireless access point (AP), device to device communication, cellular communication protocols, and Bluetooth (BT) communication protocols.

The meeting client 110 may be a software executable on the electronic device 102 or may be accessible via a web client installed on the electronic device 102. The meeting client 110 may enable the participant 124 to join, schedule, communicate, or exchange information with the one or more participants 126A...126N of a meeting session in a virtual environment. Examples of the meeting session that may be organized using the meeting client 110 may include, but are not limited to, a web conference, an audio conference, an audio-graphic conference, a video conference, a live video, a podcast session with multiple speakers, and a video call.

Each of the one or more meeting clients 114A...114N may be same as the meeting client 110. Therefore, a detailed description of the one or more meeting clients 114A...114N has been omitted from the disclosure for the sake of brevity.

The first whiteboard UI 112 may be a software executable on the electronic device 102 or may be accessible via a web client installed on the electronic device 102. In an embodiment, the first whiteboard UI 112 may be part of the meeting client UI. The first whiteboard UI 112 may enable the participant 124 to communicate and exchange information with the one or more second whiteboard UIs 116A...116N (i.e., accessible to the one or more participants 126A...126N of the meeting session). The communication and exchange of information may take place in a virtual environment based on transmission of inputs (provided by the participant 124 through a digital pen device) to the one or more second whiteboard Uls 116A...116N and reception of inputs (provided by the one or more participants 126A...126N through one or more digital pen devices) from the one or more second whiteboard Uls 116A...116N.

Each of the one or more second whiteboard UIs 116A...116N may be the same as the first whiteboard UI 112. Therefore, a detailed description of the one or more second whiteboard Uls 116A...116N has been omitted from the disclosure for the sake of brevity.

The first digital pen device 118 may include suitable logic, circuitry, interfaces, and/or code that may be configured to be used as a tool to provide inputs (such as the input 120) on whiteboard Uls (such as the first whiteboard UI 112 and the one or more second whiteboard UIs 116A...116N). The inputs may correspond to strokes. Examples of the first digital pen device 118 may include, but are not limited to, a digital pen, a digital pencil, a digital brush stylus, and a stylus pen.

The database 122 may be configured to store user profiles associated with the participant 124 and the one or more participants 126A...126N. The user profiles may be stored in the database 122 by the electronic device 102 or the meeting server 106. The user profiles may include, for example, voice samples and fingerprints of the participant 124 and the one or more participants 126A...126N. The electronic device 102 or the meeting server 106 may retrieve the user profiles and may use the retrieved profiles to authenticate the one or more participant devices 104A...104N. The one or more participant devices 104A...104N can be authenticated to accept strokes on the one or more second whiteboard Uls 116A...116N. The database 122 may be derived from data of a relational database, a non-relational database, or a set of comma-separated values (csv) files in conventional or big-data storage. The database 122 may be stored or cached on a device, such as the meeting server 106 or the electronic device 102. The device (such as the meeting server 106) storing the database 122 may be configured to receive a query for the user profiles from the electronic device 102. In response, the device storing the database 122 may be configured to retrieve and provide the queried user profiles to the electronic device 102, based on the received query.

In some embodiments, the database 122 may be hosted on a plurality of servers stored at same or different locations. The operations of the database 122 may be executed using hardware, including but not limited to, a processor, a microprocessor (e.g., to perform or control performance of one or more operations), a field-programmable gate array (FPGA), or an application-specific integrated circuit (ASIC).

In operation, the electronic device 102 may be configured to detect a user input or an event. As an example, the user input may be a command to initiate a meeting session and the event may be a detection of a meeting schedule or meeting state as ‘active’. The electronic device 102 and the one or more participant devices 104A...104N may be associated with the meeting session. The participant 124 may attend the meeting session by use of the electronic device 102. Similarly, the one or more of participants 126A...126N may attend the meeting session by use of the one or more participant devices 104A...104N. The electronic device 102 may trigger one or more operations based on the detection of the user input or the event, as described herein.

In the duration of the meeting session, the electronic device 102 may be configured to control a display device coupled to the electronic device 102 to display the first whiteboard UI 112. The first whiteboard UI 112 may be displayed inside the meeting client 110 and may be electronically linked with one or more second whiteboard Uls 116A...116N of one or more participant devices 104A...104N for a duration of the meeting session. The one or more second whiteboard Uls 116A...116N may be displayed inside the one or more meeting clients 114A...114N. Further, each whiteboard UI of the one or more second whiteboard Uls 116A...116N may be electronically linked with the first whiteboard UI 112 and other whiteboard UIs of the one or more second whiteboard UIs 116A...116N.

The electronic device 102 may be configured to receive first inputs from a participant device, via the meeting server 106. Such inputs may correspond to strokes of the first digital pen device 118 on the whiteboard UI (associated with the participant device) of the one or more second whiteboard Uls 116A...116N. In accordance with an embodiment, the first whiteboard UI 112 and each of the second whiteboard Uls 116A...116N may receive inputs corresponding to strokes of a respective digital pen device. The inputs may be relevant to the meeting content shared in the duration of the meeting session. For example, the participant 126A may use the first digital pen device 118 to apply strokes on the second whiteboard UI 116A. An example of such strokes is shown via the input 120.

The electronic device 102 may be configured to prepare content based on the first inputs and one or more content filters. For instance, the electronic device 102 may select the one or more content filters from amongst a plurality of content filters and may apply the selected one or more content filters on the received first inputs to prepare the content. The plurality of content filters may include, for example, a filter to replace a color scheme used in the first inputs with a user-defined color scheme associated with the electronic device 102, a filter to omit one or more inputs of the first inputs for the preparation of the content, a filter to edit the one or more inputs of the first inputs for the preparation of the content, a filter to add one or more labels in the content to indicate a source of the first inputs, and the like. The one or more content filters may be selected based on criteria. For example, the criteria may include a preference of the participant 124 associated with the electronic device 102, a role or a position of a participant that may be a part of the meeting session and may be associated with a participant device of the one or more participant devices 104A...104N, one or more rules agreed upon by the participant 124 and the one or more of participants 126A...126N of the meeting session, a location of the participant of the meeting session, one or more tags associated with a topic of the meeting session, and the like.

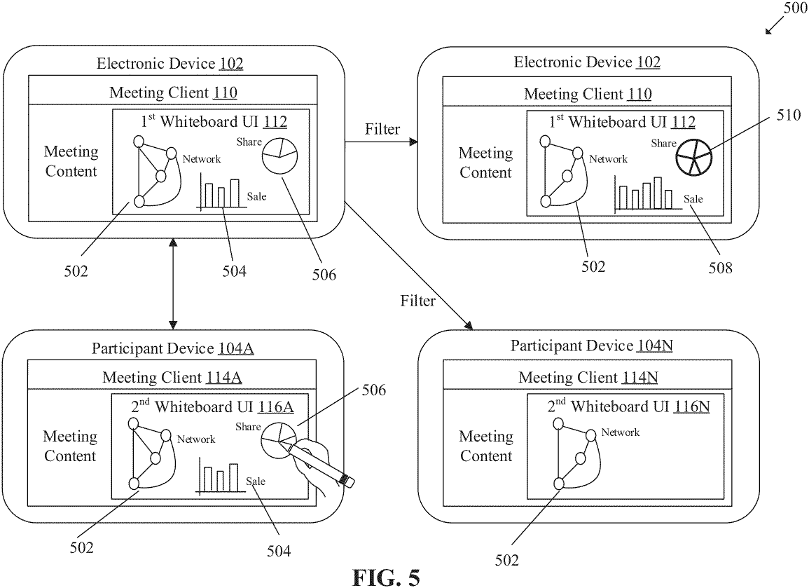

In some embodiments, the content may be prepared based on inputs corresponding to strokes applied on the first whiteboard UI 112 and on the one or more second whiteboard Uls 116A...116N. In some other embodiments, the electronic device 102 may apply the selected one or more content filters on the received inputs, based on a criterion to prepare one or more versions of the content. For example, a first content filter may be applied on the received inputs to prepare a first version of the content and a second content filter may be applied on the received inputs to prepare a second version of the content. Details of preparation of the content based on the first inputs and one or more content filters are further described, for example, in FIGS. 5, 6, and 7B.

In some embodiments, the meeting, or portions of the meeting, can be recorded by the meeting server 106 and stored in a data store such as database 122. The recording can be accessed later by authorized users to view the meeting. The recording can be accessed during the meeting to allow content from an earlier point in the meeting to be shown during the meeting. For example, a presenter can rewind the meeting to an earlier point where option one was not yet drawn on a diagram of the current system and then draw option two on top of the diagram. The rewinding of a meeting during the meeting can be done in a new layer of a whiteboard UI (such as the first whiteboard UI 112) to allow the visibility of whiteboard based on a rewind point to be controlled separately from the visibility of the whiteboard. The rewind point can be controlled based on a point in time before the rewinding to allow for switching back and forth between the new layer and a default view/layer of the whiteboard UI or showing both the new layer and a default view/layer simultaneously. The recording can contain security data to determine which users are authorized to view the recording or portions of the recording. The recording may contain information about the timing of the inputs 120 and digital pen strokes that may have been added to a whiteboard, along with any associated metadata. The recording may also contain information about the grouping, layering, or labeling of whiteboard content along with any metadata associated with groups or layers. If a user views a recording of a meeting, then the user may be allowed to control the display of the whiteboard UI as if the user is a meeting participant. Examples of the control may include, but are not limited to, applying filters, hiding content, or showing content. Security settings may limit the functionality available when viewing a recording.

In some embodiments, curated meeting or whiteboard renderings may be created to customize a presentation of the meeting or whiteboard content to a particular audience. For example, in a meeting, a rendering with the audio in English can be provided for view by people who speak English, and another rendering can be provided with the audio translated into another language. A curated rendering can have its own security settings to determine who is authorized to access the rendering. A curated rendering can be created during a meeting, which can be done by a person, can be done through settings and policies, or can be done through artificial intelligence (AI). A meeting participant may be authorized to create one or more renderings of the meeting or whiteboard while the meeting is in progress depending on the security settings of the meeting. A participant who creates a curated rendering of a meeting can provide information targeted to a particular audience, such as a translation of what is said during the meeting or notes on how what is being discussed applies to a particular team. A curated rendering can be created from a recording of a meeting. A curated rendering created from a recording may omit portions of a meeting, such as to skip over a discussion that differs from a meeting agenda. A curated rendering of a recording can include the same time period from the initial meeting more than once, such as to repeat a section of a meeting with different filters applied to highlight different things. A curated rendering of a recording can include content that was added after the recording was made, such as to add closed captioning, translations, or labels indicating which presenter is shown with each color on the whiteboard.

The electronic device 102 may be configured to control the first whiteboard UI 112 to render the prepared content on the first whiteboard UI 112. As the first whiteboard UI 112 is electronically linked with the one or more second whiteboard UIs 116A...116N, the prepared content may be simultaneously rendered on the second whiteboard UI 116N. The prepared content (as shown with the input 120) may be rendered on the first whiteboard UI 112, and the one or more second whiteboard Uls 116A...116N. Details of control of the first whiteboard UI 112 (and the one or more second whiteboard UIs 116A...116N) to render the prepared content are described, for example, in FIGS. 5, 6, 7B, 8, and 9.

The disclosed electronic device and method may enhance collaboration between the participants of the meeting session by linking all whiteboard UI (e.g., the first whiteboard UI 112 and the one or more second whiteboard UIs 116A...116N). The linking of all the whiteboard UI make it appear as if there is a single whiteboard UI that is available on all devices of the meeting session. Inputs (for example, the input 120) corresponding to strokes provided by the participant 126A on one whiteboard UI (e.g., a whiteboard UI 116A) may be rendered on all other whiteboards Uls (for example, the first whiteboard UI 112 and the second whiteboard UI 116N) associated with the meeting session. This may, in effect, lead to having a single collaborative whiteboard for participants physically associated with the meeting session and participants virtually associated with the meeting session. Further, the electronic device 102 may apply the one or more content filters on the first inputs received from the one or more second whiteboard UIs 116A...116N. The electronic device 102 may authenticate all participants, invited to participate in the meeting session, to provide inputs using digital pen devices; and, further, identify a participant based on inputs provided by the participant. Thus, collaboration amongst the whiteboard UIs, associated with the meeting session, may be achieved, and security of information exchanged during the meeting session, is ensured.

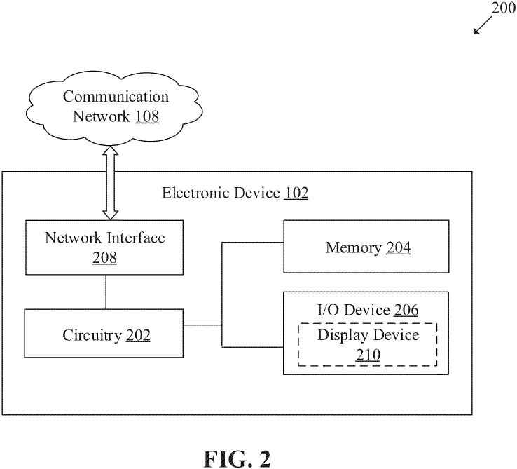

FIG. 2 is a block diagram that illustrates an exemplary electronic device for facilitation of collaboration among whiteboard Uls for meetings, in accordance with an embodiment of the disclosure. FIG. 2 is explained in conjunction with elements from FIG. 1. With reference to FIG. 2, there is shown a block diagram 200 of the electronic device 102. The electronic device 102 may include circuitry 202, a memory 204, an input/output (I/O) device 206, and a network interface 208. In at least one embodiment, the I/O device 206 may also include a display device 210. The circuitry 202 may be communicatively coupled to the memory 204, the I/O device 206, and the network interface 208, through wired or wireless communication of the electronic device 102.

The circuitry 202 may include suitable logic, circuitry, and interfaces that may be configured to execute program instructions associated with different operations to be executed by the electronic device 102. The operations may include control of the display device 210 to display the first whiteboard UI 112, which is electronically linked with the one or more second whiteboard UIs 116A...116N of the one or more participant devices 104A...104N for a duration of a meeting session. The operations may further include reception of inputs corresponding to strokes of the first digital pen device 118 on the whiteboard UI 116A. The operations may further include preparation of content based on the inputs and one or more content filters. The operations may further include control of the first whiteboard UI 112 to render the prepared content. The operations may further include authentication of the one or more participant devices 104A...104N to accept the strokes on the one or more second whiteboard Uls 116A...116N. The circuitry 202 may include one or more specialized processing units, which may be implemented as an integrated processor or a cluster of processors that perform the functions of the one or more specialized processing units, collectively. The circuitry 202 may be implemented based on a number of processor technologies known in the art. Examples of implementations of the circuitry 202 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The memory 204 may include suitable logic, circuitry, interfaces, and/or code that may be configured to store the program instructions to be executed by the circuitry 202. In at least one embodiment, the memory 204 may store the user profiles associated with the participant 124 and the one or more participants 126A...126N. The circuitry 202 may use the user profiles to authenticate the one or more participant devices 104A...104N. The user profiles may include voice samples and fingerprint samples of the participant 124 and the one or more participants 126A...126N. The authenticated one or more participant devices 104A...104N may accept strokes on the one or more second whiteboard UIs 116A...116N through digital pen devices, styluses, gesture-based inputs, touch based inputs, and so on. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the I/O device 206 may receive user inputs from the participant 124 to trigger initiation of execution of program instructions, by the circuitry 202, associated with different operations to be executed by the electronic device 102. Examples of the I/O device 206 may include, but are not limited to, a touch screen, a keyboard, a mouse, a joystick, a microphone, the display device 210, and a speaker.

The I/O device 206 may include the display device 210. The display device 210 may include suitable logic, circuitry, and interfaces that may be configured to receive inputs from the circuitry 202 to render, on a display screen, content of the meeting client 110. Examples of the content of the meeting client 110 may include, but not related to, meeting-related content and the first whiteboard UI 112. The first whiteboard UI 112 may receive user inputs, from the participant 124 or the one or more participant devices 104A...104N, that may be relevant to the displayed meeting content. Th user inputs may be received as strokes on the one or more second whiteboard Uls 116A...116N through digital pen devices and styluses. The display screen may be a touch screen which may enable the participant 124 to provide a touch-input or a gesture-input via the display device 210 or the display screen. The touch screen may be at least one of a resistive touch screen, a capacitive touch screen, or a thermal touch screen. The display device 210 or the display screen may be realized through several known technologies such as, but not limited to, at least one of a Liquid Crystal Display (LCD) display, a Light Emitting Diode (LED) display, a plasma display, or an Organic LED (OLED) display technology, or other display devices.

The network interface 208 may include suitable logic, circuitry, and interfaces that may be configured to facilitate a communication between the circuitry 202, the one or more participant devices 104A...104N, and the meeting server 106, via the communication network 108. The network interface 208 may be implemented by use of various known technologies to support wired or wireless communication of the electronic device 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, or a wireless network, such as a cellular telephone network, a wireless local area network (LAN), a short-range communication network, and a metropolitan area network (MAN). The wireless communication may use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a near field communication protocol, and a wireless pear-to-pear protocol.

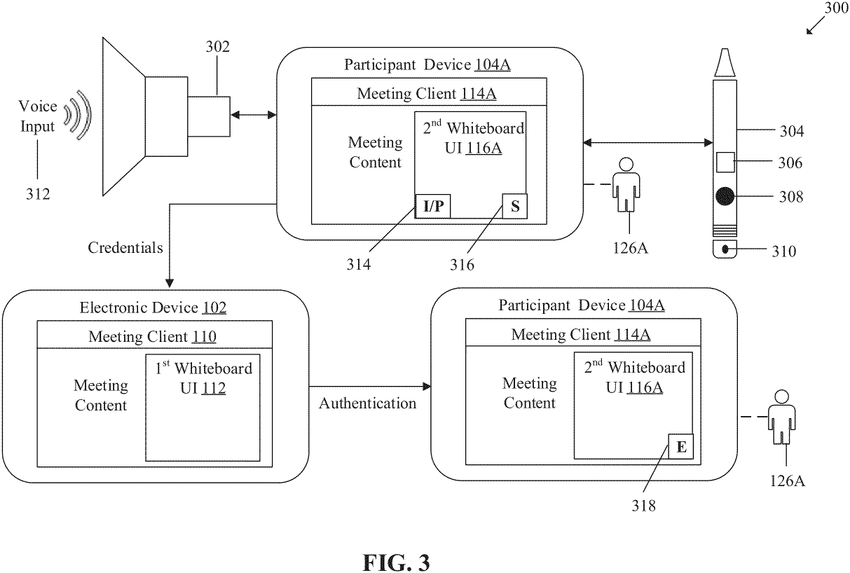

The functions or operations executed by the electronic device 102, as described in FIG. 1, may be performed by the circuitry 202. Operations executed by the circuitry 202 are described in detail, for example, in FIGS. 3, 4, 5, 6 7A, 7B, 8, and 9.

FIG. 3 is a diagram that illustrates an exemplary scenario for authentication of a participant of a virtual meeting session to use a digital pen device with a whiteboard UI, in accordance with an embodiment of the disclosure. FIG. 3 is explained in conjunction with elements from FIG. 1 and FIG. 2. With reference to FIG. 3, there is shown an exemplary scenario diagram 300. In the exemplary scenario diagram 300, there is shown one or more components of FIG. 1, such as the electronic device 102 and the participant device 104A. There is further shown an audio-capture device 302 and a digital pen device 304. As an example, the audio-capture device 302 may be a speaker. The digital pen device 304 may be identical to the first digital pen device 118.

The electronic device 102 may include the meeting client 110, which enables the electronic device 102 to join or host the meeting session with the participant device 104A. The electronic device 102 may render the first whiteboard UI 112 on a UI of the meeting client 110. The participant device 104A may include the meeting client 114A and render the second whiteboard UI 116A inside a UI of the meeting client 114A. The meeting client 110 may be linked with the meeting client 114A. The first whiteboard UI 112 may be electronically linked with the second whiteboard UI 116A.

In the exemplary scenario diagram 300, a set of operations may be performed by the electronic device 102 to authenticate the participant device 104A, as described herein. The circuitry 202 of the electronic device 102 may be configured to authenticate the participant device 104A based on information provided by the participant device 104A. The participant device 104A may receive the information based on inputs provided by the participant 126A. The authentication may ensure secure collaboration amongst the participants of the meeting session.

In an embodiment, the participant device 104A may be authenticated based on a voice input 312 that may be captured via the audio-capture device 302. To setup voice-based authentication, the circuitry 202 of the electronic device 102 may accept voice samples of one or more users associated with the participant device 104A. For example, the participant device 104A may accept a voice sample of the participant 126A associated with the participant device 104A. The participant device 104A may be further configured to send the voice sample to the electronic device 102, where the voice sample may be stored in the memory 204. Similarly, the electronic device 102 may store voice samples of the one or more users associated with the participant device 104A. At any time-instant in a duration of the meeting session, the participant device 104A may receive the voice input 312 via the audio-capture device 302 and may send the voice input 312 to the electronic device 102 as credentials of the participant 126A. The circuitry 202 of the electronic device 102 may be configured to detect whether a match exists between the voice input 312 and one of the stored voice samples. Thereafter, the circuitry 202 of the electronic device 102 may authenticate the participant device 104A based on the match, After the authentication, the participant device 104A may be allowed to receive inputs via the second whiteboard UI 116A.

In another embodiment, the participant device 104A may be authenticated based on a selection of a user profile associated with the first digital pen device 118 (or the digital pen device 304). The circuitry 202 of the electronic device 102 may be configured to authenticate the participant device 104A based on the selected user profile. For profile-based authentication, the electronic device 102 may store a plurality of user profiles that may be associated with the digital pen device 304. The stored plurality of user profiles may include a user profile that includes touch samples of the participant 126A. As an example, the touch samples may refer to fingerprint samples. The electronic device 102 may store the user profile of participant 126A upon reception of fingerprint samples (of the participant 126A) from the participant device 104A.

At any time-instant, the digital pen device 304 may scan a fingerprint of the participant 126A via a fingerprint detector 306 in the digital pen device 304. The participant device 104A may be configured to send the fingerprint to the electronic device 102 as credentials of the participant 126A. The circuitry 202 of the electronic device 102 may be configured to detect whether a match exists between the fingerprint (received as credentials of the participant 126A) with fingerprint samples in one of the stored user profiles associated with the digital pen device 304. The circuitry 202 of the electronic device 102 may select a user profile that includes fingerprint samples matching the received fingerprint (of the participant 126A). The circuitry 202 of the electronic device 102 may authenticate the participant device 104A to receive inputs via the second whiteboard UI 116A, based on the match.

In another embodiment, the participant device 104A may be authenticated based on a selection of a button 310 on the first digital pen device 118 (the digital pen device 304). The circuitry 202 of the electronic device 102 may be configured to authenticate the participant device 104A based on the selection of the button 310. The participant device 104A may receive sample selections of the button 310 from a plurality of users that include the participant 126A, via the digital pen device 304. As an example, the sample selections may refer to sequences of pressing actions (such as the participant 126A pressing the button 310 for a predefined number of times). The participant device 104A may be configured to send the sample sequences of pressing actions to the electronic device 102. The electronic device 102 may store such selections (sequences of pressing actions). Thereafter, the participant device 104A may receive a selection of the button 310 via the digital pen device 304. The digital pen device 304 may be configured to send the selection (the participant 126A pressing the button 310 for the predefined number of times) to the participant device 104A. The participant device 104A may be configured to send the selection to the electronic device 102 as credentials of the participant 126A. The circuitry 202 of the electronic device 102 may be configured to detect whether a match exists between the credentials of the participant 126A and one of the samples stored on the electronic device 102. The circuitry 202 of the electronic device 102 may authenticate the participant device 104A to receive inputs, on the second whiteboard UI 116A, on detection of a match.

In another embodiment, the participant device 104A may be authenticated based on a selection of one or more user identifiers via the second whiteboard UI 116. The circuitry 202 of the electronic device 102 may be configured to authenticate the participant device 104A based on the selection of a user identifier of the one or more user identifiers. The user identifier may include, for example, a fingerprint, a signature, a voice pattern, a facial scan, a password, and the like. Such a selection may be performed via a button 314 on the second whiteboard UI 116A.

In another embodiment, the participant device 104A may be authenticated based on a scan of a digital identity badge. The circuitry 202 of the electronic device 102 may authenticate the participant device 104A based on the scan of the digital identity badge. The digital pen device 304 may include a scanner 308 or the scanner 308 may be communicatively coupled with the digital pen device 304. The scanner 308 may be configured to identify whether a digital identity badge (scanned via the scanner 308) is valid. The electronic device 102 may store identities of a plurality of authentic digital identity badges. For example, the identity may include a bar code, a QR code, a combination of codes, and the like. When the participant 126A uses the scanner 308 to scan the digital identity badge assigned to the participant 126A, the scanner 308 of the digital pen device 304 may read the identity of the scanned digital identity badge. The digital pen device 304 (or the scanner 308) may transmit information (includes the read identity) associated with the scanned badge to the participant device 104A. The circuitry 202 of the electronic device 102 may receive the information and may detect whether the identity of the scanned digital identity badge is valid based on a plurality of valid digital identity badges stored on the electronic device 102. The circuitry 202 of the electronic device 102 may be configured to authenticate the participant device 104A to receive inputs corresponding to strokes of the digital pen device 304 on the second whiteboard UI 116A.

Prior to the authentication of the participant device 104A, the second whiteboard UI 116A may indicate that the participant 126A is in a “spectator” mode. For example, an indication “S” 316 may be rendered on the second whiteboard UI 116A to demonstrate that the participant 126A is in a “spectator” mode. In “spectator” mode, the first whiteboard UI 112 may not accept strokes provided on the first whiteboard UI 112 by the participant 126A. However, inputs corresponding to strokes received from the electronic device 102 or another authenticated participant device of the one or more participant devices 104A...104N may be rendered on the first whiteboard UI 112.

After the participant device 104A is authenticated (and authorized), the first whiteboard UI 112 may accept strokes of the digital pen device 304. The second whiteboard UI 116A may indicate that the participant 126A is authorized to provide inputs on the second whiteboard UI 116A. For example, an indication “E” 318 may be rendered on the second whiteboard UI 116A to demonstrate that the participant 126A is in an “editor” mode. This indicates that the participant device 104A has been authenticated and can accept strokes of the digital pen device 304 via the second whiteboard UI 116A.

In some embodiments, the one or more of the items, such as the scanner 308 or button 310, may be part of a participant device or may be in other peripheral devices that communicate with the participant device or the digital pen device 304. In some embodiments, hardware that is part of the participant device, such as the audio-capture device 302, may be built into a digital pen device 304 in addition to or instead of being part of the participant device.

In accordance with an embodiment, the digital pen device 304 may be implemented as a stylist device which may resemble a traditional pen or marker. The functionality of the digital pen device 304 may be provided by a variety of devices other than a stylist device, including but not limited to, a mouse, a touch screen, a tablet, a virtual reality system, a laser pointer, a gesture recognition device, an eye tracking device, a camera that is capable of detecting strokes of a physical pen or marker, the first whiteboard UI 112, the meeting server 106, or an application programing interface (API). In some embodiments, multiple devices may be used with the same meeting client 110. In some other embodiments, different meting clients 114A may use different devices to implement the digital pen device 304.

The strokes generated by the digital pen device 304 may be in different forms, including but not limited to, a free-form line, a straight line, a line that has corners or bends, an arrow, a drawing shape such as an ellipse or rectangle, a text which may include formatting, an image, an emoji, an avatar, a video which may include audio, a recording or a meeting, a recording from earlier in this whiteboard session, a recording from a different whiteboard session, a slide presentation, a chart, a graph, a document, or an audio. In some embodiments, a stroke may be a video or audio source that is streamed, which may be from a live source. Recordings from a whiteboard session may be a portion of the whiteboard or the whole whiteboard. Such recordings may be from a particular point in time or may be a playback of the whiteboard over time. If a recording from a whiteboard session is only a portion of the whiteboard, the portion of the whiteboard recording can be selected by any criteria. By way of example, and not limitation, the criteria that can be used to control the display of the current whiteboard session may be based on at least one of a selected area of the whiteboard, the presenters that contributed the content in the meeting session, a timestamp, a time range, a styling, a groups of strokes, layers, applied filters, an originating meeting client, or an originating participant device. A digital pen device may be set to create strokes that are used to erase other content. Such erasures may be limited to content in a particular group or layer or may be limited to content that meets certain criteria, such as having meta-data with a particular tag or from a particular presenter. Erasures may be done in a non-destructive manner by layering the erasing on top of other content, such as in the form of a filtering mask which can be turned on/off or can be inverted to show just content that may have been erased from the whiteboard UI. Erasing strokes may be treated like other strokes, which allow the strokes to be recorded and to be controlled individually in different renderings of the whiteboard UI. For example, a first participant in a meeting may create a new layer and erase an option one that was drawn and draw an option two on the local whiteboard UI while a second presenter may be talking about option one (that may be shown on other whiteboard renderings). When the first presenter starts to talk about option two, the visibility of the new layer may be turned on for other participants. As the visibility turns on, the whiteboard UI may erase option one and show option two via the new layer.

In these or other embodiments, stokes may include alpha transparency information. In some embodiments, strokes may include information on how the stokes layer with other strokes, For example, the information may be about options to obscure, erase, mask, or filter strokes in overlapping layers of content inside a whiteboard UI.

In some embodiments, metadata may be associated with strokes created by a digital pen device 304. The metadata may include security information such as labels, tags, restrictions, groups, or roles. The metadata may include but is not limited to timing data, source whiteboard device, source presenter, line width, color, labels (such as “phase one” or “option B”), a relationship with other stokes, display options (such as default color, size, position, opacity, shadow effects, line thickness, or line pattern), or temporal effects (such as blinking, shimmering, fade-in, fade-out, or color cycling). The metadata may include an association with other stokes such as an audio stroke created by the presenter while creating the stroke or group of strokes.

In some embodiments, multiple strokes may be combined into groups, which can be treated like layers. Operations that can be applied to a stroke may also be applied to a group of strokes. Metadata that may be associated with a stroke may be associated with a group of strokes. For example, a presenter A may add an image to the whiteboard and a presenter B may draw a set of annotations on top of that image. The image and annotations may be grouped together so that the display of the image and the annotation can be done by applying it to the group instead of applying it to the individual strokes, such as hiding, showing, realigning, scaling, transforming, restyling, or moving the display of the group. Restyling effects may include, for example, a change in color, size, line width, font styles, and the like. Layers or groups may be created based on various traits, including but not limited to, a portion of a cropped stroke, a cropped group, a cropped layer, a portion of a whiteboard display, a timestamp, a time range, a sequence of events, strokes by a presenter, or a category. A category may separate strokes by a criterion, such as strokes from whiteboards in a particular office location or from a particular set of employees. A group or layer may include filters applied to one or more strokes within the group or layer.

In some embodiments, a new layer may be created to group content that may have been added to the whiteboard. For example, a first presenter may create a first new layer and may draw an option one on top of a diagram that may have already been displayed on a whiteboard UI, while a second presenter creates a second new layer and draws option two on top of the diagram. This visibility of option one and option two may be controlled independently by changing settings for the layers. The change in the settings may allow the presenter or a participant to easily switch back and forth between the two options via a whiteboard UI. In some cases, the layer for option one may be displayed beside the layer for option two, with the background behind those layers showing through in both locations.

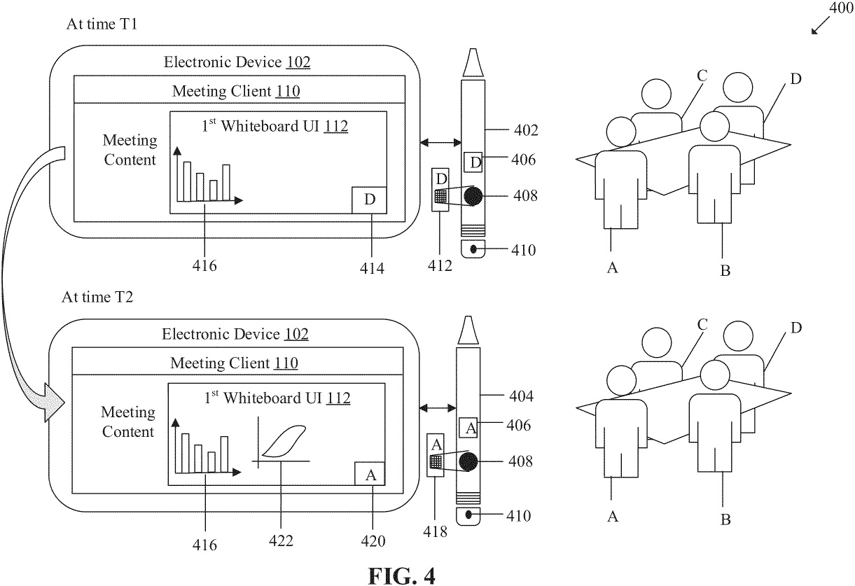

FIG. 4 is a diagram that illustrates an exemplary scenario for authentication of participants of a meeting session to use a digital pen device, in accordance with an embodiment of the disclosure. FIG. 4 is explained in conjunction with elements from FIG. 1, FIG. 2, and FIG. 3. With reference to FIG. 4, there is shown an exemplary scenario diagram 400. In the exemplary scenario diagram 400, there is shown one or more components of FIG. 1, such as the electronic device 102. There is further shown a digital pen device 402 The functionality of the digital pen device 402 may be similar or identical to the digital pen device 304. The electronic device 102 may include a UI of the meeting client 110, which enables the electronic device 102 to display meeting content and the first whiteboard UI 112. The UI of the meeting client 110 (or the first whiteboard UI 112) is shown at two-time instants, i.e., a first time instant (T-1) when a participant ‘D’ uses the digital pen device 402 to provide inputs corresponding to strokes of the digital pen device 402, and a second time-instant (T-2) when a participant ‘A’ uses the digital pen device 402 to provide inputs corresponding to strokes of the digital pen device 402. The digital pen device 402 may recognize the participant (‘D’ or ‘A’) providing the input based on the authentication (performed in FIG. 3).

As shown in FIG. 4, four participants, viz., ‘A’, ‘B’, ‘C’, and ‘D’ attend a meeting session in a physical location. The electronic device 102 may be present in the physical location. The four participants may take turns to provide inputs via the first whiteboard UI 112 by use of the digital pen device 402. The circuitry 202 of the electronic device 102 may be configured to receive a plurality of prestored profiles for a list of participants of the meeting session. The list of participants includes a participant ‘A’, a participant ‘B’, a participant ‘C’, and a participant ‘D’. Each prestored profile may include information (that may pertain to a participant) such as a fingerprint sample, a sample facial scan, a pattern, an identity associated with a digital identity badge, and so on. The circuitry 202 of the electronic device 102 may receive the prestored profiles via the digital pen device 402. Each participant may provide a respective fingerprint sample, a sample facial scan, or a pattern via a touch input detector 406. Additionally, or alternatively, each participant may provide a respective digital identity badge for a scan via a scanner 408. Each participant may provide a respective fingerprint sample via a button 410.

The digital pen device 402 may be configured to send the plurality of prestored profiles for the list of participants to the electronic device 102. The electronic device 102 may receive the plurality of prestored profiles. The circuitry 202 of the electronic device 102 may be further configured to determine an active user of the second digital pen device (such as the digital pen device 402) from the list. The circuitry 202 may determine one of the participants ‘A’, ‘B’, ‘C’, or ‘D’ as the active user. At the first-time instant T-1, ‘D’, may be identified as the active user. The circuitry 202 of the electronic device 102 may identify ‘D’ as the active user based on an input received from ‘D’ via the touch input detector 406 (fingerprint of ‘D’, facial scan of ‘D’, or a pattern of inputs provided by of ‘D’) or via the scanner 408 (by determination of the identity associated with the digital identity badge of the participant ‘D’ 412) based on scan of the digital identity badge 412 by the scanner 408) or an input via the button 410 (fingerprint of ‘D’).

The circuitry 202 of the electronic device 102 may be further configured to select a prestored profile associated with the active user, from the plurality of prestored profiles. For example, the prestored profile associated with the participant ‘D’ may be selected at the first-time instant T-1, if the participant ‘D’ is determined to be the active user. The circuitry 202 of the electronic device 102 may be further configured to configure a second digital pen device (i.e., the digital pen device 402) with the selected prestored profile. For example, the digital pen device 402 may be configured with the prestored profile associated with the participant ‘D’. Thereafter, the participant ‘D’ may be authenticated to (and authorized to) provide inputs via the first whiteboard UI 112 by use of the digital pen device 402.

In accordance with an embodiment, the circuitry 202 of the electronic device 102 may be configured to render an indication 414. The indication (e.g., a name) may indicate the active user of the digital pen device 402. Upon authentication, the first whiteboard UI 112 may receive an input 416 from the participant ‘D’.

At the second time instant T-2, the participant ‘A’ may be identified as the active user based on an input (fingerprint of ‘A’ or pattern provided by of ‘A’), received via the touch input detector 406. The participant ‘A’ may also be identified as the active user based on an input received via the scanner 408 (e.g., by determination of the identity associated with a digital identity badge that belongs to ‘A’ 418 upon a scan of the digital identity badge 418) or via the button 410 (e.g., a fingerprint of ‘A’). Thereafter, the circuitry 202 of the electronic device 102 may select the prestored profile associated with participant ‘A’ and may configure the digital pen device 402 with the prestored profile associated with participant ‘A’. Thereafter, participant ‘A’ may be authenticated (and authorized) to provide inputs via the first whiteboard UI 112 by use of the digital pen device 402. In accordance with an embodiment, the circuitry 202 of the electronic device 102 may be configured to render an indication 420. The indication may indicate participant ‘A’ as the active user of the digital pen device 402. Upon authentication, the first whiteboard UI 112 may receive an input 422 from ‘A’.

FIG. 5 is a diagram that illustrates an exemplary scenario for preparation of content based on one or more content filters and inputs received through a digital pen device, in accordance with an embodiment of the disclosure. FIG. 5 is explained in conjunction with elements from FIG. 1, FIG. 2, FIG. 3, and FIG. 4. With reference to FIG. 5, there is shown an exemplary scenario diagram 500. In the exemplary scenario diagram 500, there is shown one or more components of FIG. 1, such as the electronic device 102, the participant device 104A, and the participant device 104N. The electronic device 102 may include the meeting client 110. The electronic device 102 may be configured to render the first whiteboard UI 112 inside the UI of the meeting client 110. Similarly, the participant device 104A may include the meeting client 114A and may render the second whiteboard UI 116A inside the UI of the meeting client 114A. Similarly, the participant device 104N may include the meeting client 114N and may render the second whiteboard UI 116N on the UI of the meeting client 114N.

As shown in FIG. 5, the circuitry 202 may receive first inputs corresponding to strokes of the first digital pen device 118. For example, such inputs may be provided through the second whiteboard UI 116A and may correspond to a first stroke 502 (a network), a second stroke 504 (a bar chart that indicates sales of networking products for three consecutive years), and a third stroke 506 (a pie chart that indicates holdings of market shares by companies that manufacture such products). In an embodiment, the first inputs may be received as an event stream that follows a sequence in which the strokes appear on the second whiteboard UI 116A. For example, the second whiteboard UI 116A may receive an event stream that follows the first stroke 502, the second stroke 504, and the third stroke 506 in a sequence. For example, the first stroke 502 may be received first, the second stroke 504 may follow the first stroke 502, and the third stroke 506 may follow the second stroke 504.

Upon reception of the inputs, the circuitry 202 of the electronic device 102 may be configured to select one or more content filters from a plurality of content filters. Based on first inputs and the selected content filter(s), the circuitry 202 may prepare content. Specifically, the content may be prepared based on application of the selected filter(s) on the first inputs. By way of example, and not limitation, the plurality of content filters may include a filter to replace a color scheme used in the first inputs with a user-defined color scheme associated with the electronic device 102, a filter to change thickness of lines used in the first inputs, a filter to omit one or more inputs of the first inputs for the preparation of the content, a filter to edit the one or more inputs of the first inputs for the preparation of the content, and a filter to add one or more labels in the content to indicate a source of the first inputs.

In accordance with an embodiment, the circuitry 202 of the electronic device 102 may be configured to select the one or more content filters based on a preference of the participant 124 associated with the electronic device 102, a role or a position of a participant (of one or more of participants 126A...126N) that may be part of the meeting session and may be associated with one of the participant devices 104A...104N, one or more rules agreed upon by the participant 124 and the one or more of participants 126A...126N of the meeting session, a location of the participant of the meeting session, and one or more tags associated with a topic of the meeting session.

In an embodiment, the circuitry 202 of the electronic device 102 may select the filter to edit the one or more inputs of the first inputs for the preparation of the content. For example, the filter may be applied on the second stroke 504. The application of the filter may lead to the creation of a fourth stroke 508. The second stroke may be edited to include data that indicates sales of the networking products for two additional years or sales forecast of the networking products for upcoming years. The selection of the filter may be based on the preference of the participant 124 associated with the electronic device 102. The participant 124 may prefer to edit the second stroke 504 to include additional data.

In an embodiment, the circuitry 202 of the electronic device 102 may select the filter to change thickness of lines used in the first inputs. For example, the filter may be applied on the third stroke 506. The application of the filter may lead to the creation of a fifth stroke 510. The selection of the filter may be based on a rule (agreed upon by the participant 124 and the one or more of participants 126A...126N) to change thickness of lines used to stroke pie charts or market shares holdings. Thus, the prepared content may include the first stroke 502, the fourth stroke 508, and the fifth stroke 510. The circuitry 202 of the electronic device 102 may be configured to control the first whiteboard UI 112 to render the prepared content on the first whiteboard UI 112.

In another embodiment, a filter may be applied to strokes, groups, or layers based on information contained in the associated meta-data.

In some embodiments, a content filter may be associated with one or more rules that may apply when rule criteria are met. For example, if an input is received on the first whiteboard UI 112, then a rule for a content filter may cause the input to be rendered in front of everything that is behind the filter and hide strokes in front of the filter (drawn by other presenters).

In another embodiment, the circuitry 202 of the electronic device 102 may select the filter to omit one or more inputs of the first inputs for the preparation of the content. For example, the filter may be applied on the second stroke 504 and the third stroke 506 to omit the second stroke 504 and the third stroke 506 during the preparation of the content. The selection of the filter may be based on a role or a position of the participant 126N associated with the participant device 104N. For example, the participant 126N may have a technical role or a technical position and may want to focus on technical details of products (discussed in the meeting session). The participant 126N may not be concerned with sales data of such products or holdings of market shares by companies that manufacture such products.

In accordance with an embodiment, the selection of the filter may be performed based on the location of the participant 126N. For example, for the preparation of the content for a participant whose location is ‘Dubai’, the circuitry 202 may select and apply a filter to omit one or more inputs of the first inputs. Before the filter is applied, the circuitry 202 may be configured to request the participant device 104N or the meeting server 106 to provide the location of the participant device 104N (or the participant 126N). If the location of the participant 126N is determined to be ‘Dubai’, the second stroke 504 and the third stroke 506 may be omitted during the preparation of the content. Thus, the prepared content may only include the first stroke 502 for the participant whose location is ‘Dubai’. The prepared content may be rendered on the second whiteboard UI 116N.

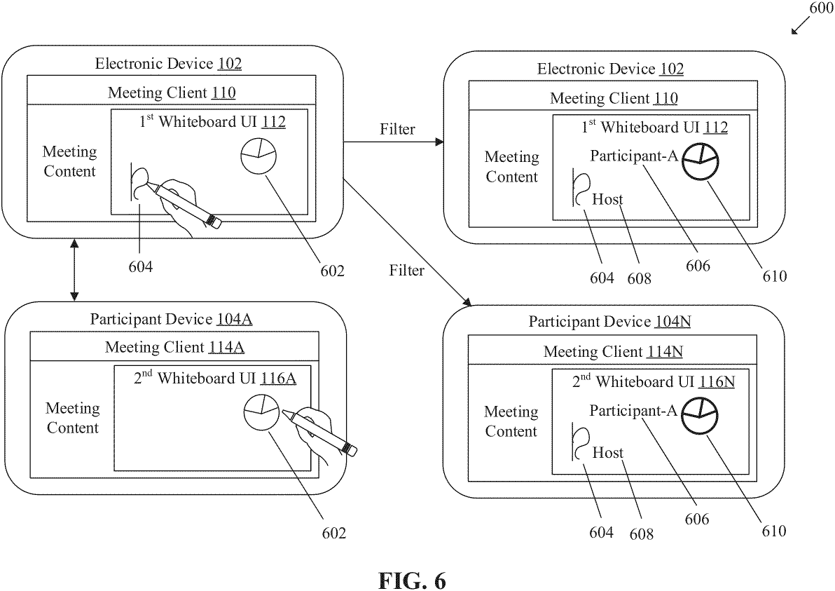

FIG. 6 is a diagram that illustrates an exemplary scenario for preparation of content based on one or more content filters and inputs received through one or more digital pen devices, in accordance with an embodiment of the disclosure. FIG. 6 is explained in conjunction with elements from FIG. 1, FIG. 2, FIG. 3, FIG. 4, and FIG. 5. With reference to FIG. 6, there is shown exemplary scenario diagram 600. In the exemplary scenario diagram 600, there is shown one or more components of FIG. 1, such as the electronic device 102, the participant device 104A, and the participant device 104N.

As shown, for example, the first inputs received by the electronic device 102 may correspond to a first stroke 602. Such inputs may be provided via the second whiteboard UI 116A by use of the first digital pen device 118. As the first whiteboard UI 112 is linked with the one or more second whiteboard Uls 116A...116N, the first stroke 602 may be rendered on the first whiteboard UI 112. The circuitry 202 of the electronic device 102 may be further configured to receive second inputs corresponding to strokes of a second digital pen device on the first whiteboard UI 112. As shown, for example, the second inputs may correspond to a second stroke 604 rendered on the first whiteboard UI 112.

In an embodiment, the circuitry 202 of the electronic device 102 may select a filter to add one or more labels in the content to indicate a source of the first inputs and a source of the second inputs. For example, the filter may be applied on the first stroke 602 and the second stroke 604. The application of the filter may add a first label 606 next to the first stroke 602 to indicate that the source of the first input is ‘participant-A’ (or the participant 126A). The application of the filter may add a second label 608 next to the second stroke 604 to indicate that the source of the first input is ‘host’ (or the participant 124). The selection of the filter may be based on the one or more rules agreed upon by the participant 124 and the one or more of participants 126A...126N of the meeting session. The rule may necessitate indicating the source of received inputs (such as the first inputs and the second inputs) as ‘participant-A’ and ‘host’.

The circuitry 202 of the electronic device 102 may further select the filter to change thickness of lines used in the first inputs. For example, the filter may be applied on the first stroke 602. The application of the filter may lead to the creation of a third stroke 610. The selection of the filter may be based on a rule (agreed upon by the participant 124 and the one or more of participants 126A...126N) to change thickness of lines used to stroke pie charts or market shares holdings.

The circuitry 202 of the electronic device 102 may be configured to prepare content based on the selected one or more content filters and the first inputs (and/or the second inputs). The prepared content may include the second stroke 604, the first label 606 (indicating the source of the third stroke 610 created by application of content filter on the first stroke 602), the second label 608 (indicating the source of the second stroke 604), and the third stroke 610. After the preparation of the content, the circuitry 202 may control the first whiteboard UI 112 to render the prepared content on the second whiteboard UI 116N.

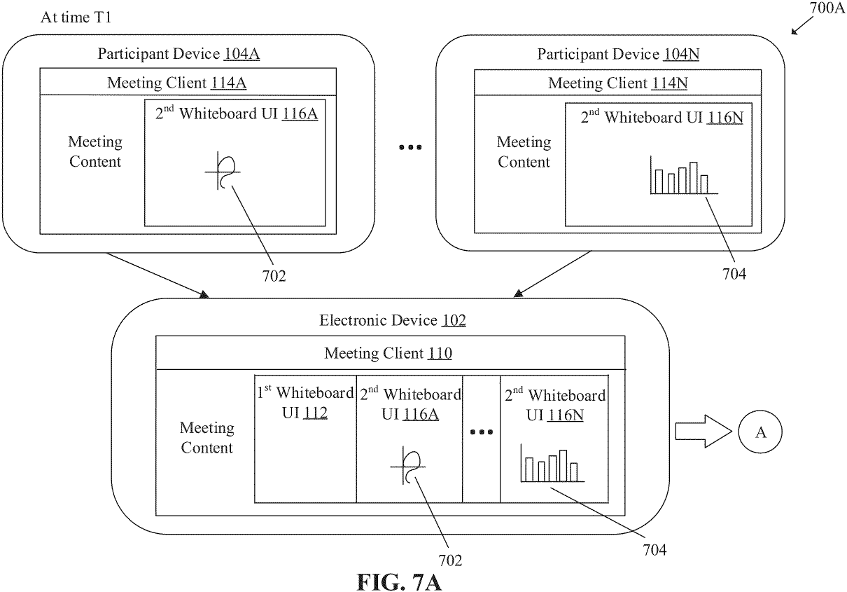

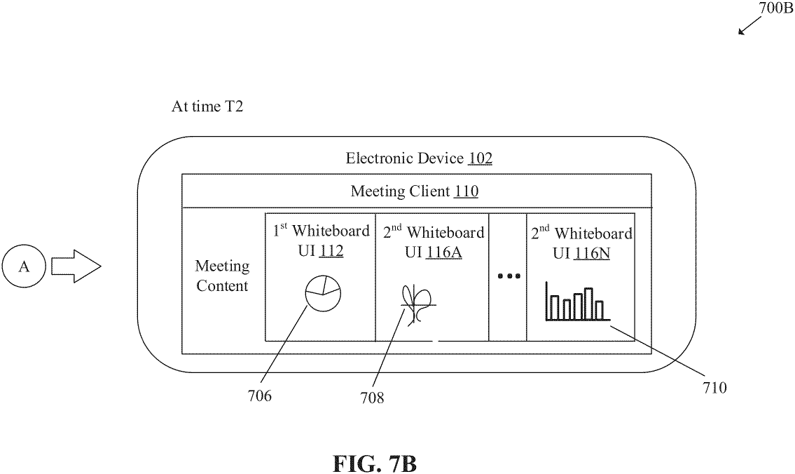

FIG. 7A is a diagram that illustrates an exemplary scenario for display of one or more whiteboard Uls as tiles on a window UI, in accordance with an embodiment of the disclosure. FIG. 7A is explained in conjunction with elements from FIG. 1, FIG. 2, FIG. 3, FIG. 4, FIG. 5, and FIG. 6. With reference to FIG. 7A, there is shown an exemplary scenario diagram 700A. In the exemplary scenario diagram 700A, there is shown one or more components of FIG. 1, such as the electronic device 102, and the one or more participant devices 104A...104N. The participant device 104A may include the meeting client 114A and may render the second whiteboard UI 116A on the UI of the meeting client 114A. Similarly, the participant device 104N may include the meeting client 114N and may render the second whiteboard UI 116N on the UI of the meeting client 114N. The electronic device 102 may include the meeting client 110.

The circuitry 202 of the electronic device 102 may be configured to display the first whiteboard UI 112 and each of the one or more second whiteboard UIs 116A...116N in the UI of the meeting client 110. Inputs received on each of the one or more second whiteboard UIs 116A...116N may be simultaneously displayed in the UI of the meeting client 110. For example, the circuitry 202 of the electronic device 102 may be configured to display a window UI (inside the UI of the meeting client 110, for example) that includes the first whiteboard UI 112 and the one or more second whiteboard UIs 116A...116N as tiles. The arrangement of tiles in FIG. 7A is an example and such an example should not be construed as limiting. The one or more tiles that represent the one or more second whiteboard UIs 116A...116N may be linked to the respective one or more second whiteboard UIs 116A...116N on the one or more participant devices 104A...104N.

The UI of the meeting client 110 is shown at a first time instant (T-1). The tile that represents the second whiteboard UI 116A may render an input 702. The input 702 may be received via strokes on the second whiteboard UI 116A of the participant device 104A. The tile that represents the second whiteboard UI 116N may also render an input 704. The input 704 may be received via strokes on the second whiteboard UI 116N of the participant device 104N.

The input 702 (as shown inside the second whiteboard UI 116A that is displayed as a tile) and the input 704 (as shown inside the second whiteboard UI 116N that is displayed as another tile) in the UI of the meeting client 110 are not to be construed as limiting. In some embodiments, user inputs may be received to select the one or more second whiteboard UIs 116A...116N to be included in the window UI. The user input can be received from the participant 124 associated with the electronic device 102. In some cases, the user input may indicate that a preference of the participant 124 to view all the one or more second whiteboard UIs 116A...116N inside the UI of the meeting client 110.

FIG. 7B is a diagram that illustrates an exemplary scenario for display of prepared content on one or more whiteboard Uls inside a window UI, in accordance with an embodiment of the disclosure. FIG. 7B is explained in conjunction with elements from FIG. 1, FIG. 2, FIG. 3, FIG. 4, FIG. 5, FIG. 6, and FIG. 7A. With reference to FIG. 7B, there is shown an exemplary scenario diagram 700B. In the exemplary scenario diagram 700B, there is shown one or more components of FIG. 1, such as the electronic device 102, and the one or more participant devices 104A...104N.

The UI of the meeting client 110 is shown at a second time instant (T-2). The circuitry 202 of the electronic device 102 may be configured to receive an input 706 through a tile that represents the first whiteboard UI 112. The input 706 may be received in the form of strokes applied on the first whiteboard UI 112 (as part of the window UI). The circuitry 202 of the electronic device 102 may be further configured to prepare content based on the first inputs (for example, the input 702 and the input 704) and one or more content filters. For example, the content filters may include a filter to edit the one or more inputs of the first inputs for the preparation of the content and a filter to change the thickness of lines used in the first inputs).

In accordance with an embodiment, the circuitry 202 of the electronic device 102 may select the filter to edit the one or more inputs of the first inputs for the preparation of the content. The first inputs may correspond to the input 702 rendered on the tile representing the second whiteboard UI 116A. The selected filter may be applied on the input 702. The application of the filter may lead to the creation of the input 708. As shown, for example, the input 702 may be a graph (Nyquist plot) that represents the stability of a system. The input 702 may be edited to create the input 708 that represents an effect of addition of one or more components to the system to improve the stability of the system. The selection of the filter may be based on, for example, the preference of the participant 124 associated with the electronic device 102. The input 708 may be rendered on the tile representing the second whiteboard UI 116A.

The circuitry 202 of the electronic device 102 may be further configured to select the filter to change the thickness of lines used in the first inputs. The first inputs may correspond to the input 704 rendered on the tile (that represents the second whiteboard UI 116N). The selected filter may be applied on the input 704 and the application of the filter may lead to the creation of the input 710. The selection of the filter may be based on, for example, a rule (agreed upon by the participant 124 and the one or more of participants 126A...126N) to change the thickness of lines used to represent bar charts that indicate sales data pertaining to a product. The input 710 may be rendered on the tile representing the second whiteboard UI 116N.

The prepared content may be rendered on a whiteboard UI displayed inside the window UI (for example, the UI of the meeting client 110). The circuitry 202 of the electronic device 102 may be further configured to render the prepared content on the one or more tiles (which represents the one or more second whiteboard UIs 116A...116N). Inside the window UI, the input 706 may be rendered on the first whiteboard UI 112 (i.e., a tile), the input 708 may be rendered on the second whiteboard UI 116A (i.e., a tile), and the input 710 may be rendered on the second whiteboard UI 116N (i.e., a tile).

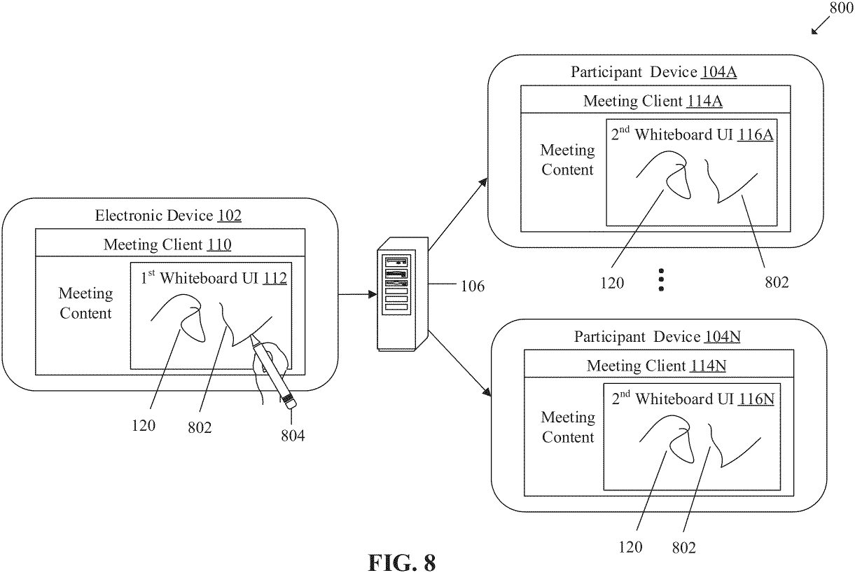

FIG. 8 is a diagram that illustrates an exemplary network environment for transmission of inputs to participant devices via a meeting server, in accordance with an embodiment of the disclosure. FIG. 8 is explained in conjunction with elements from FIG. 1, FIG. 2, FIG. 3, FIG. 4, FIG. 5, FIG. 6, FIG. 7A, and FIG. 7B. With reference to FIG. 8, there is shown an exemplary scenario diagram 800. In the exemplary scenario diagram 800, there is shown one or more components of FIG. 1, such as the electronic device 102, the one or more participant devices 104A...104N, and the meeting server 106. The electronic device 102 may include the meeting client 110 and may render the first whiteboard UI 112 inside the UI of the meeting client 110. Similarly, the one or more participant devices 104A...104N may include the one or more meeting clients 114A...114N. The Uls of the one or more meeting clients 114A...114N may render the one or more second whiteboard UIs 116A...116N.

As shown in FIG. 8, the circuitry 202 of the electronic device 102 may be configured to receive second inputs 802 that correspond to strokes of a second digital pen device 804 on the first whiteboard UI 112. The functionality of the second digital pen device 804 may be similar or identical to the digital pen device 402. The second inputs 802 may be received while the first inputs (for example, the input 120) are rendered on the first whiteboard UI 112 and the one or more second whiteboard UIs 116A...116N. The circuitry 202 of the electronic device 102 may be configured to transmit the second inputs 802 to each of the one or more participant devices 104A...104N via the meeting server 106. Upon reception, the meeting server 106 may transmit the second inputs 802 to each of the one or more participant devices 104A...104N.

The one or more participant devices 104A...104N may receive the second inputs 802 from the meeting server 106. The second inputs 802 may be rendered on each of the one or more second whiteboard UIs 116A...116N along with the first inputs (for example, the input 120).

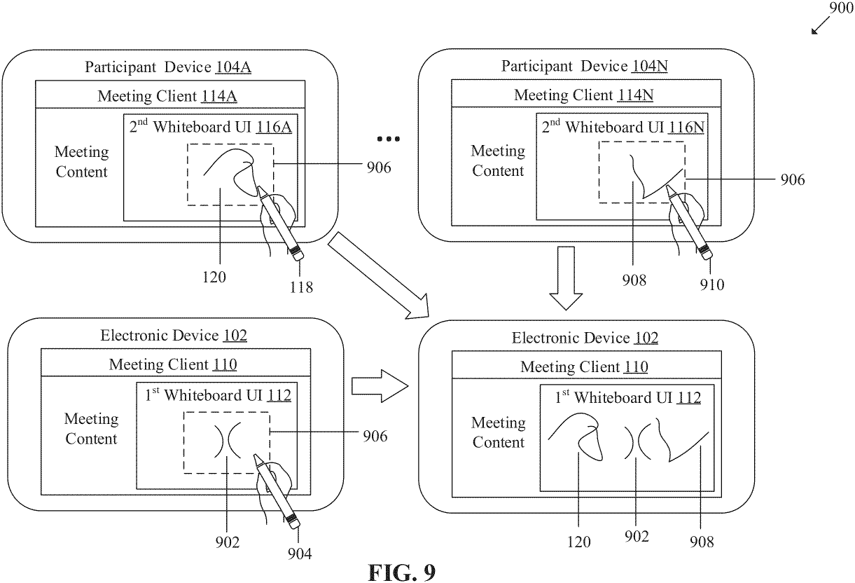

FIG. 9 is a diagram that illustrates an exemplary scenario for rendering of content within separate areas of a whiteboard UI, in accordance with an embodiment of the disclosure. FIG. 9 is explained in conjunction with elements from FIG. 1, FIG. 2, FIG. 3, FIG. 4, FIG. 5, FIG. 6, FIG. 7A, FIG. 7B, and FIG. 8. With reference to FIG. 9, there is shown an exemplary scenario diagram 900. In the exemplary scenario diagram 900, there is shown one or more components of FIG. 1, such as the electronic device 102, and the one or more participant devices 104A...104N. The electronic device 102 may include the meeting client 110 and may render the first whiteboard UI 112 inside the UI of the meeting client 110. The one or more participant devices 104A...104N may include the one or more meeting clients 114A...114N. The UIs of the one or more meeting clients 114A...114N may render the one or more second whiteboard UIs 116A...116N.

The first whiteboard UI 112 and the one or more second whiteboard UIs 116A...116N may receive inputs that correspond to a common display region. In some instances, the correspondence may result in overlap between the inputs for the first whiteboard UI 112 (and on the one or more second whiteboard Uls 116A...116N). The inputs may be received when multiple participants (for example, the participant 124, the participant 126A, and the participant 126N) explain or discuss any topic as part of the meeting content. The concept may be explained through strokes via their respective whiteboards (e.g., the first whiteboard UI 112, the second whiteboard UI 116A, and the second whiteboard UI 116N) at the same time. As the first whiteboard UI 112 and the one or more second whiteboard UIs 116A...116N may be linked electronically, the strokes may overlap with one another, if not filtered.

At any time-instant in the duration of a meeting session, the circuitry 202 of the electronic device 102 may be configured to receive inputs that correspond to strokes of a plurality of digital pen devices on the first whiteboard UI 112 and the one or more second whiteboard UIs 116A...116N. The received inputs may include the first inputs (such as the input 120 shown in FIG. 1). The received inputs may include, for example, an input 902 that corresponds to strokes of a digital pen device 904, the input 120 (the first inputs) that corresponds to strokes of the first digital pen device 118, and an input 908 that corresponds to strokes of a digital pen device 910. The functionality of the digital pen device 904 may be similar or identical to the digital pen device 402 and the second digital pen device 804.

Each of the inputs, i.e., the input 902, the input 120, and the input 908 may correspond to a common display region 906 of the first whiteboard UI 112 and the one or more second whiteboard UIs 116A...116N.

The circuitry 202 of the electronic device 102 may be further configured to prepare the content further based on the received inputs (the inputs 902, 120, and 908). The prepared content may be rendered such that portions of the content corresponding to the plurality of digital pen devices (for example, the digital pen device 904, the first digital pen device 118, and the digital pen device 910) appears within separate areas (display regions) of the first whiteboard UI 112. For example, the circuitry 202 of the electronic device 102 may change display positions of the inputs 120 and 908. This may prevent an overlap between a display position of the input 902 and a display position of the input 908, the display positions of the inputs 902 and 120, and the display positions of the inputs 120 and 908.

In some embodiments, the circuitry 202 may control the rendering of the prepared content on the first whiteboard UI 112. The rendering of the prepared content may be based on selection of inputs (strokes, groups, and/or layers) based on metadata associated with the inputs. The content to be rendered may be prepared based on the selected inputs. The metadata used for selection may be a timestamp or a time range. The selected content filters may be applied to the selected inputs (strokes, groups and/or layers) to hide, show, move to a different display, and the like. For example, the circuitry 202 may select an input received from the participant devices 104A. A filter may be applied to change the color or thickness of the input. In some instances, a user input that indicates a selection of a timestamp or a time range may be received. The circuitry 202 may control the meeting client 110 to pause the meeting session and play a recording of the meeting session from the selected timestamp or a portion of the recording of the meeting session indicated by the time range. The circuitry 202 may apply filters to control the volume of audio content received from each of the one or more participant devices 104A...104N. A meeting attendee may see different views of the whiteboard UI to determine what portions the attendee wishes to see on their display, which can be useful for a meeting attendee that curates a rendering of the whiteboard to be shown on meeting client 110.

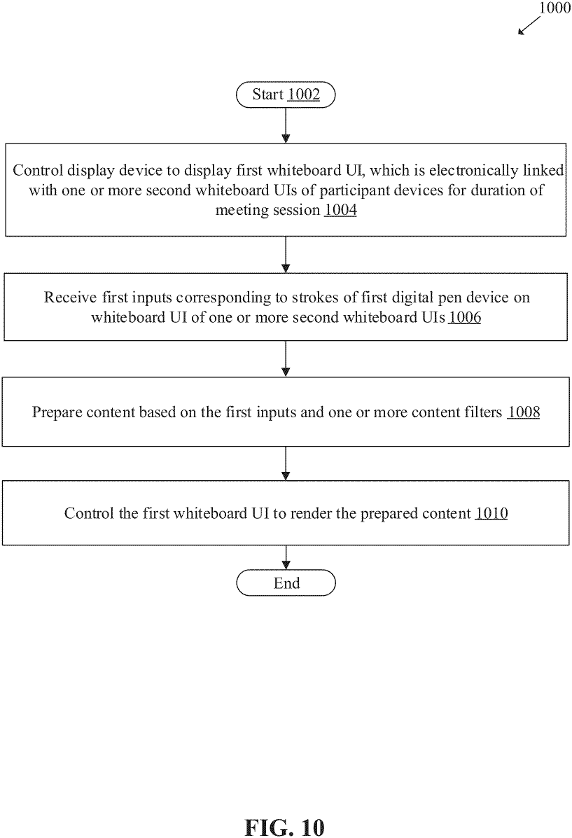

FIG. 10 is a flowchart that illustrates exemplary operations for collaboration among whiteboard Uls for meetings, in accordance with an embodiment of the disclosure. FIG. 10 is explained in conjunction with elements from FIGS. 1, 2, 3, 4, 5, 6, 7A, 7B, 8 and 9. With reference to FIG. 10, there is shown a flowchart 1000. The operations from 1002 to 1010 may be implemented by any computing system, such as by the electronic device 102 of FIG. 1. The operations may start at 1002 and may proceed to 1004.

At 1004, the display device 210 may be controlled to display the first whiteboard UI 112 where the first whiteboard UI 112 may be electronically linked with the one or more second whiteboard Uls 116A...116N of participant devices 104A...104N for a duration of the meeting session. In at least one embodiment, the circuitry 202 may be configured to control the display device 210 to display the first whiteboard UI 112. The first whiteboard UI 112 may be electronically linked with the one or more second whiteboard UIs 116A...116N of participant devices 104A...104N for the duration of the meeting session.

At 1006, first inputs corresponding to strokes of the first digital pen device 118 may be received on a whiteboard UI of the one or more second whiteboard Uls 116A...116N. In at least one embodiment, the circuitry 202 may be configured to receive first inputs corresponding to strokes of the first digital pen device 118 on the whiteboard UI of the one or more second whiteboard Uls 116A...116N. The details of determination of the receive first inputs corresponding to strokes of the first digital pen device 118 on the whiteboard UI of the one or more second whiteboard UIs 116A...116N, are described, for example, in FIGS. 5, 6, 7A, 7B, 8, and 9.

At 1008, content may be prepared based on the first inputs and one or more content filters. In at least one embodiment, the circuitry 202 may be configured to prepare the content based on the first inputs and the one or more content filters. The details of preparation of the content based on the first inputs and the one or more content filters, are described, for example, in FIGS. 5, 6, 7A, 7B, 8, and 9.

At 1010, the first whiteboard UI 112 may be controlled to render the prepared content. In at least one embodiment, the circuitry 202 may be configured to control the first whiteboard UI 112 to render the prepared content. Control may pass to end.

Although the flowchart 1000 is illustrated as discrete operations, such as 1004, 1006, 1008, and 1010 the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (such as the electronic device 102). The computer-executable instructions may cause the machine and/or computer to perform operations that include control of a display device 210, communicatively coupled to the electronic device 102, to display a first whiteboard UI 112, which is electronically linked with one or more second whiteboard Uls 116A...116N of participant devices 104A...104N for a duration of a meeting session. The operations may further include reception of first inputs corresponding to strokes of a first digital pen device 118 on a whiteboard UI of the one or more second whiteboard UIs 116A...116N. The operations may further include preparation of content based on the first inputs and one or more content filters. The operations may further include control of the first whiteboard UI 112 to render the prepared content.

Exemplary aspects of the disclosure may include an electronic device (such as the electronic device 102 of FIG. 1) that may include circuitry (such as the circuitry 202), that may be communicatively coupled to one or more electronic devices (such as the one or more participant devices 104A...104N, of FIG. 1). The electronic device 102 may further include memory (such as the memory 204 of FIG. 2). The circuitry 202 may be configured to control a display device 210, communicatively coupled to the electronic device 102, to display the first whiteboard UI 112. The first whiteboard UI 112 may be electronically linked with the one or more second whiteboard UIs 116A...116N of the one or more participant devices 104A...104N for a duration of a meeting session. The circuitry 202 may be further configured to receive first inputs (such as the input 120) corresponding to strokes of the first digital pen device (such as the first digital pen device 118) on a whiteboard UI of the one or more second whiteboard UIs 116A...116N. The circuitry 202 may be further configured to prepare content based on the first inputs and one or more content filters. The circuitry 202 may be further configured to control the first whiteboard UI 112 to render the prepared content. In accordance with an embodiment, the first inputs may be received as an event stream that follows a sequence in which the strokes appear on the whiteboard UI of the one or more second whiteboard UIs 116A...116N.

In accordance with an embodiment, the circuitry 202 may be configured to authenticate a participant device of the one or more participant devices 104A...104N. The whiteboard UI of the one or more second whiteboard Uls 116A...116N may be associated with the participant device. The participant device may be authenticated to accept the strokes on the whiteboard UI of the one or more second whiteboard UIs 116A...116N. The participant device of the one or more second whiteboard UIs 116A...116N may be authenticated based on at least one of a voice input via an audio-capture device (such as a speaker) communicatively coupled with the participant device, a selection of a user profile associated with the first digital pen device (such as the digital pen device 402) communicatively coupled with the participant device, a selection of a button on the first digital pen device 118, a selection of one or more user identifiers (e.g., using the button 314) via the whiteboard UI, and a scan of a digital identity badge.

In accordance with an embodiment, the circuitry 202 may be further configured to receive a plurality of prestored profiles for a list of participants (such as participants A, B, C, and D, depicted in FIG. 4) of the meeting session. The circuitry 202 may be further configured to determine an active user of a second digital pen device (such as the digital pen device 402) from the list. The circuitry 202 may be further configured to select a prestored profile associated with the active user, from the plurality of prestored profiles. The circuitry 202 may be further configured to configure the second digital pen device with the selected prestored profile.

In accordance with an embodiment, the circuitry 202 may be further configured to select the one or more content filters from a plurality of content filters. The plurality of content filters include a filter to replace a color scheme used in the first inputs with a user-defined color scheme associated with the electronic device 102, a filter to omit one or more inputs of the first inputs for the preparation of the content, a filter to edit the one or more inputs of the first inputs for the preparation of the content, and a filter to add one or more labels in the content to indicate a source of the first inputs. The content may be prepared further based on application of the selected one or more content filters on the first inputs. The one or more content filters may be selected based on at least one of a preference of a user associated with the electronic device 102, a role or a position of a participant that is part of the meeting session and is associated with one of the participant devices 104A...104N, one or more rules agreed upon by the user and the participants of the meeting session, a location of the participant, and one or more tags associated with a topic of the meeting session.

In accordance with an embodiment, the circuitry 202 may be further configured to control the display device 210 to display a window UI that includes the first whiteboard UI 112 and the one or more second whiteboard UIs 116A...116N as tiles, in the duration of the virtual meeting session. The circuitry 202 may be further configured to render the prepared content on the whiteboard UI of the one or more second whiteboard UIs 116A...116N inside the window UI.

In accordance with an embodiment, the circuitry 202 may be further configured to receive second inputs (such as the second inputs 802) that correspond to strokes of a second digital pen device (such as the second digital pen device 804) on the first whiteboard UI 112. The circuitry 202 may be further configured to transmit the second inputs to each of the one or more participant devices 104A...104N via the meeting server 106.

In accordance with an embodiment, the circuitry 202 may be further configured to receive inputs (such as inputs 902, 908, and 912) corresponding to strokes of a plurality of digital pen devices (such as digital pen devices 904, 910, and 118) on the first whiteboard UI 112 and the one or more second whiteboard UIs 116A...116N. The received inputs may include the first inputs (such as the input 120 depicted as the input 908). The circuitry 202 may be further configured to prepare the content based on the received inputs. The content may be rendered such that portions of the content corresponding to the plurality of digital pen devices appear within separate areas of the first whiteboard UI 112.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry communicatively coupled to a display device, wherein the circuitry is configured to:
control the display device to display a first whiteboard User Interface (UI), which is electronically linked with one or more second whiteboard Uls of participant devices for a duration of a meeting session;
receive credential information from a participant device of the participant devices,
wherein the credential information indicates selection of a button of a first digital pen device for a specific number of times;
authenticate the participant device based on the selection of the button of the first digital pen device for the specific number of times;
receive, based on the authentication of the participant device, first inputs corresponding to strokes of the first digital pen device on a whiteboard UI of the one or more second whiteboard Uls, wherein
the whiteboard UI is associated with the participant device, and
the participant device is authenticated to accept the strokes on the whiteboard UI;
select at least one content filter of a plurality of content filters, wherein
the at least one content filter is a filter to add one or more labels in content, and
the one or more labels indicate a source of the first inputs;
prepare the content by application of the selected at least one content filter on the first inputs; and
control the first whiteboard UI to render the prepared content.

2. (canceled)

3. The electronic device according to claim 1, wherein the participant device is authenticated based on at least one of:
a voice input via an audio-capture device communicatively coupled with the participant device,
a selection of a user profile associated with the first digital pen device that is communicatively coupled with the participant device,
a selection of one or more user identifiers via the whiteboard UI, and
a scan of a digital identity badge.

4. The electronic device according to claim 1, wherein the circuitry is further configured to:
receive a plurality of prestored profiles for a list of participants of the meeting session;
determine an active user of a second digital pen device from the list;
select a prestored profile associated with the active user, from the plurality of prestored profiles; and
configure the second digital pen device with the selected prestored profile.

5. The electronic device according to claim 1, wherein the plurality of content filters includes:
a filter to replace a color scheme used in the first inputs with a user-defined color scheme associated with the electronic device,
a filter to omit one or more inputs of the first inputs for the preparation of the content,
a filter to edit the one or more inputs of the first inputs for the preparation of the content,
a filter to change a thickness of at least one of the first inputs, and
one or more filters to control a volume of audio content received from each of the participant devices.

6. The electronic device according to claim 1, wherein the at least one content filter is selected based on at least one of:
a preference of a first participant associated with the electronic device,
a role or a position of a second participant that is part of the meeting session and is associated with one of the participant devices,
one or more rules agreed upon by the first participant and the second participant of the meeting session,
a location of the second participant that is part of the meeting session and is associated with one of the participant devices, and
one or more tags associated with a topic of the meeting session.

7. The electronic device according to claim 1, wherein
the circuitry is further configured to control the display device to display a window UI that includes the first whiteboard UI and the one or more second whiteboard Uls as tiles, and
the prepared content is rendered on the whiteboard UI that is displayed inside the window UI.

8. The electronic device according to claim 1, wherein the first inputs are received as an event stream that follows a sequence in which the strokes appear on the whiteboard UI.

9. The electronic device according to claim 1, wherein the circuitry is further configured to:
receive second inputs that correspond to strokes of a second digital pen device on the first whiteboard UI; and
transmit the second inputs to each of the participant devices via a meeting server.

10. The electronic device according to claim 1, wherein
the circuitry is further configured to:
receive inputs corresponding to strokes of a plurality of digital pen devices on the first whiteboard UI and the one or more second whiteboard Uls, wherein the received inputs include the first inputs; and
prepare the content based on the received inputs, and
the content is rendered such that portions of the content corresponding to the plurality of digital pen devices appear within separate areas of the first whiteboard UI.

11. The electronic device according to claim 10, wherein the plurality of digital pen devices includes a second digital pen device associated with the electronic device.

12. A method, comprising:
in an electronic device:
controlling a display device, communicatively coupled to the electronic device, to display a first whiteboard User Interface (UI), which is electronically linked with one or more second whiteboard Uls of participant devices for a duration of a meeting session;
receiving credential information from a participant device of the participant devices,
wherein the credential information indicates selection of a button of a first digital pen device for a specific number of times;
authenticating the participant device based on the selection of the button of the first digital pen device for the specific number of times;
receiving, based on the authentication of the participant device, first inputs corresponding to strokes of the first digital pen device on a whiteboard UI of the one or more second whiteboard Uls, wherein
the whiteboard UI is associated with the participant device, and
the participant device is authenticated to accept the strokes on the whiteboard UI; selecting at least one content filter of a plurality of content filters, wherein
the at least one content filter is a filter to add one or more labels in content, and
the one or more labels indicate a source of the first inputs;
preparing the content by application of the selected at least one content filter on the first inputs; and
controlling the first whiteboard UI to render the prepared content.

13. (canceled)

14. The method according to claim 12, wherein the participant device is authenticated based on at least one of:
a voice input via an audio-capture device communicatively coupled with the participant device,
a selection of a user profile associated with the first digital pen device that is communicatively coupled with the participant device,
a selection of one or more user identifiers via the whiteboard UI, and
a scan of a digital identity badge.

15. The method according to claim 12, further comprising:
receiving a plurality of prestored profiles for a list of participants of the meeting session;
determining an active user of a second digital pen device from the list;
selecting a prestored profile associated with the active user, from the plurality of prestored profiles; and
configuring the second digital pen device with the selected prestored profile.

16. The method according to claim 12, wherein the plurality of content filters includes:
a filter to replace a color scheme used in the first inputs with a user-defined color scheme associated with the electronic device,
a filter to omit one or more inputs of the first inputs for the preparation of the content,
a filter to edit the one or more inputs of the first inputs for the preparation of the content,
a filter to change a thickness of at least one of the first inputs, and
one or more filters to control a volume of audio content received from each of the participant devices.

17. The method according to claim 12, wherein the at least one content filter is selected based on at least one of:
a preference of a first participant associated with the electronic device,
a role or a position of a second participant that is part of the meeting session and is associated with one of the participant devices,
one or more rules agreed upon by the first participant and the second participant of the meeting session,
a location of the second participant that is part of the meeting session and is associated with one of the participant devices, and
one or more tags associated with a topic of the meeting session.

18. The method according to claim 12, further comprising controlling the display device to display a window UI that includes the first whiteboard UI and the one or more second whiteboard Uls as tiles,
wherein the prepared content is rendered on the whiteboard UI that is displayed inside the window UI.

19. The method according to claim 12, further comprising
receiving second inputs that correspond to strokes of a second digital pen device on the first whiteboard UI; and
transmitting the second inputs to each of the participant devices via a meeting server.

20. A non-transitory computer-readable storage medium configured to store instructions that, in response to being executed, cause an electronic device to perform operations, the operations comprising:
controlling a display device, communicatively coupled to the electronic device, to display a first whiteboard User Interface (UI), which is electronically linked with one or more second whiteboard Uls of participant devices for a duration of a meeting session;
receiving credential information from a participant device of the participant devices,
wherein the credential information indicates selection of a button of a first digital pen device for a specific number of times;
authenticating the participant device based on the selection of the button of the first digital pen device for the specific number of times;
receiving, based on the authentication of the participant device, first inputs corresponding to strokes of the first digital pen device on a whiteboard UI of the one or more second whiteboard Uls, wherein
the whiteboard UI is associated with the participant device, and
the participant device is authenticated to accept the strokes on the whiteboard UI;
selecting at least one content filter of a plurality of content filters, wherein
the at least one content filter is a filter to add one or more labels in content, and
the one or more labels indicate a source of the first inputs;
preparing the content by application of the selected at least one content filter on the first inputs; and
controlling the first whiteboard UI to render the prepared content.
